(19) United States
(12) Patent Application Publication
(10) Pub. No.: US 2024/0376238 A1
(43) Pub. Date: Nov. 14, 2024

(54) DUAL-CURE RESIN FOR PREPARING CHEMICAL MECHANICAL POLISHING PADS

(71) Applicant: CMC Materials LLC, Aurora, IL (US)

(72) Inventor: Achla Khanna, Naperville, IL (US)

(21) Appl. No.: 18/653,839

(22) Filed: May 2, 2024

Related U.S. Application Data
(60) Provisional application No. 63/465,175, filed on May 9, 2023.

(51) Int. Cl. C08F 220/34; B24B 37/24; B24D 18/00; B29C 64/124; B29K 33/00; B29K 105/00; B33Y 10/00; B33Y 70/00

(52) U.S. Cl. CPC C08F 220/34; B24B 37/24; B24D 18/0018; B33Y 70/00; B29C 64/124; B29K 2033/00; B29K 2105/0002; B29K 2105/0005; B33Y 10/00

(57) ABSTRACT

A dual-cure resin formulation having an improved pot life is described. The dual cure resin may be used to fabricate a CMP pad using a 3D printing process.

### RELATED APPLICATION

This application claims priority to and the benefit of U.S. Provisional Application No. 63/465,175 filed May 9, 2023, which is incorporated herein by reference in its entirety for all purposes.

### TECHNICAL FIELD

This disclosure generally relates to chemical mechanical polishing, and more specifically to a dual-cure resin for preparing chemical mechanical polishing pads.

### BACKGROUND

An integrated circuit is typically formed on a substrate by the sequential deposition of conductive, semi-conductive, and/or insulative layers on a silicon wafer. A variety of fabrication processes require planarization of at least one of these layers on the substrate. For example, for certain applications (e.g., polishing of a metal layer to form vias, plugs, and lines in the trenches of a patterned layer), an overlying layer is planarized until the top surface of a patterned layer is exposed. In other applications (e.g., planarization of a dielectric layer for photolithography), an overlying layer is polished until a desired thickness remains over the underlying layer. Chemical-mechanical planarization, also known as chemical-mechanical polishing (both referred to as “CMP”), is one accepted method of planarization. This planarization method typically requires that the substrate be mounted on a carrier head. The exposed surface of the substrate is typically placed against a polishing pad on a rotating platen. The carrier head provides a controllable load (e.g., a downward force) on the substrate to push it against the rotating polishing pad. A polishing liquid, such as slurry with abrasive particles, may also be disposed on the surface of the polishing pad during polishing.

One objective of a CMP process is to achieve a high polishing uniformity. If different areas on the substrate are polished at different rates, then it is possible for some areas of the substrate to have too much material removed (“overpolishing”) or too little material removed (“underpolishing”). Conventional polishing pads, including standard pads and fixed-abrasive pads, may suffer from these problems. A standard pad may have a polyurethane polishing layer with a roughened surface and may also include a compressible backing layer. A fixed abrasive pad has abrasive particles held in a containment media and is typically supported on an incompressible backing layer.

These conventional polishing pads are typically prepared by molding, casting or sintering polyurethane materials. Molded polishing pads must be prepared one at a time (e.g., by injection molding). For casting polishing pads, a liquid precursor is cast and cured into a “cake,” which is subsequently sliced into individual pad sections. These pad sections must then be machined to a final thickness. Polishing pads prepared using conventional extrusion-based processes generally lack desirable properties for CMP (e.g., are too brittle for effective CMP).

CMP pads may also be formed using an additive manufacture process such as a 3D printing process or a vat-based additive manufacturing process. Each layer of the plurality of layers may be formed via UV-initiated reaction of a precursor material to form a thin layer of solidified pad material. The resulting pad is thus formed with a precisely controlled structure by projecting an appropriate pattern of light (e.g., UV irradiation) for forming each thin layer.

The present disclosure seeks to provide an improved dual-cure resin for preparing CMP pads using an additive manufacturing process.

### BRIEF DESCRIPTION OF THE DRAWINGS

To assist in understanding the present disclosure, reference is now made to the following description taken in conjunction with the accompanying drawings, in which:

FIG. 1 is a block diagram illustrating a composition of a dual-cure resin for preparing CMP pads, according to an illustrative embodiment of this disclosure;

FIG. 2 is a flowchart of an example process for preparing the composition of FIG. 1 and using the composition to prepare CMP pads;

FIG. 3 illustrates a chemical reaction for forming acrylate-capped oligomers, according to an illustrative embodiment of this disclosure;

FIGS. 4 and 5 illustrate chemical reactions in the composition of FIG. 1 during performing UV and thermal curing processes, according to an illustrative embodiment of this disclosure;

FIG. 6 is a plot of a viscosity of a composition of a dual-cure resin according to an illustrative embodiment of this disclosure;

FIG. 7 is a plot of a viscosity of a composition of a dual-cure resin, according to an illustrative embodiment of this disclosure;

FIG. 8 is a plot of removal rates achieved by different sample CMP pads, according to an illustrative embodiment of this disclosure;

FIG. 9 is a plot demonstrating a planarization efficiency (PE) achieved by the different sample CMP pads, according to an illustrative embodiment of this disclosure; and

FIG. 10 is a plot of pad wear rates for different sample CMP pads, according to an illustrative embodiment of this disclosure.

While the disclosure is amenable to various modifications and alternative forms, specifics thereof have been shown by way of example in the drawings and will be described in detail. It should be understood, however, that the intention is not to limit aspects of the disclosure to the particular illustrative embodiments described. On the contrary, the intention is to cover all modifications, equivalents, and alternatives falling within the spirit and scope of the disclosure.

### DETAILED DESCRIPTION

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better explain the disclosure and does not pose a limitation on the scope of claims.

The term “about” generally refers to a range of numbers that is considered equivalent to the recited value (e.g., having the same function or result). In many instances, the term “about” may include numbers that are rounded to the nearest significant figure.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Numerical ranges expressed using endpoints include all numbers subsumed within that range (e.g. 1 to 5 includes 1, 1.5, 2, 2.75, 3, 3.80, 4 and 5).

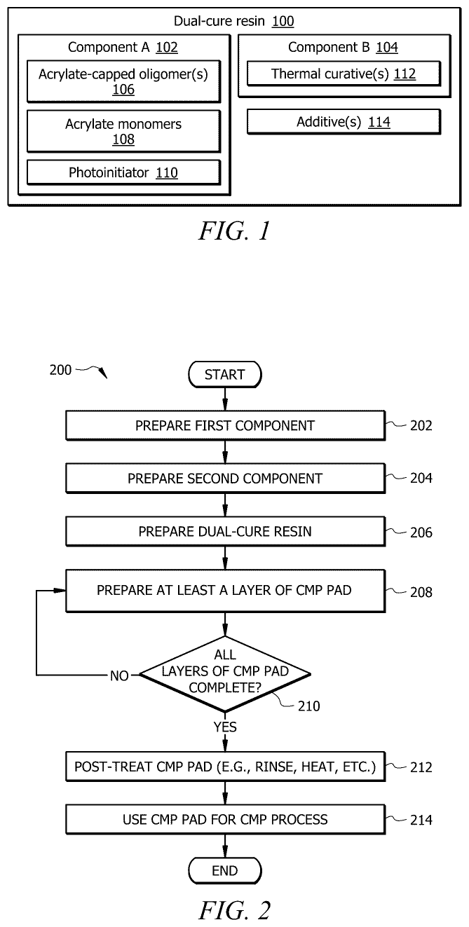

FIG. 1 illustrates an example composition of a dual-cure resin 100 for making a CMP pad. The dual-cure resin 100 includes a first component 102 (Component A) and a second component 104 (Component B). The first component 102 includes one or more acrylate-capped oligomers 106, one or more acrylate monomers 108, and at least one photoinitiator 110. In some cases, first component 102 may also include a chain extender. As used herein, the term “acrylate” refers to methacrylates and acrylates. The second component 104 includes one or more thermal curatives 112. Further details and examples of subcomponents of the first component 102 and second component 104 are provided below. The dual-cure resin 100 may optionally include additives 114, described further below.

The dual-cure resin 100 may be solidified by exposing the dual-cure resin 100 to ultraviolet (UV) light and then subsequently heating the dual-cure resin 100 to perform thermal curing. As described in greater detail below with respect to FIGS. 6-10, the dual-cure resin 100 of this disclosure is able to achieve an improved pot life while maintaining comparable removal rates (RR) and planarization efficiencies (PE) to those of previous CMP pads by adjusting amounts of various components included in the dual-cure resin 100. In addition, the pad wear rate (PWR) is similar to that of previous CMP pads.

The acrylate capped oligomers 106 may be selected from permanently capped acrylate aromatic urethane oligomers, permanently capped aliphatic acrylate oligomers, de-blockable capped acrylate aromatic urethane oligomers, de-blockable capped acrylate aliphatic urethane oligomers, and combinations thereof. In certain embodiments, the acrylate-capped oligomers 106 may be formed by reacting acrylate blocking agents with isocyanate-terminated urethane prepolymers. In some embodiments, the blocking agents may be de-blockable. The acrylate blocking agents may comprise 2-hydroxyethyl acrylate (HEA), 2-hydroxyethyl methacrylate (HEMA), 2-(tert-butylamino) ethyl methacrylate (TBEMA), 3-(acryloyloxy)-2-hydroxypropyl methacrylate (AHPMA), combinations thereof, or the like. The isocyanate-terminated urethane prepolymers may comprise aromatic prepolymers (e.g., PET60D, PET75D, PET80A, PET90A, and PET95A, commercially available from Coim USA, Inc., and 80DPLF, commercially available from Anderson Development Company), and aliphatic prepolymers (e.g., APC722, APC504, 51-95A, etc., also available commercially from Coim USA, Inc.).

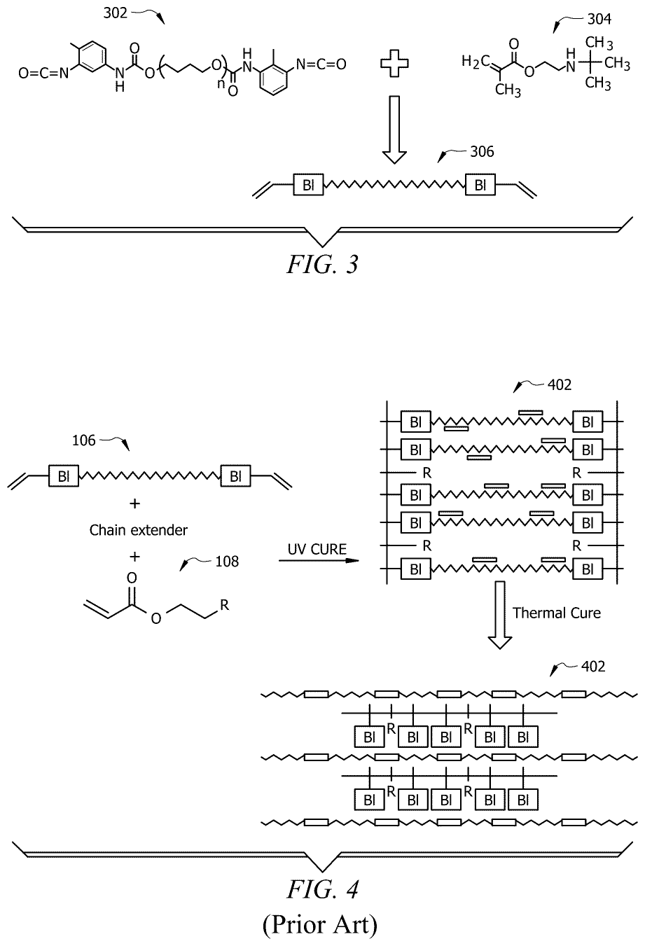

In certain embodiments, permanently blocked acrylate urethane oligomers may be prepared by reacting HEA with aromatic isocyanate-terminated urethane prepolymers. In certain embodiments, de-blockable capped acrylate urethane oligomers may be prepared by reacting TBEMA with aromatic/aliphatic isocyanate-terminated urethane prepolymers. An example of such a reaction is illustrated in FIG. 3, where aromatic urethane prepolymer 302 reacts with TBEMA 304 to form de-blockable acrylate-capped aromatic urethane oligomer 306.

The acrylate monomers 108 may act as reactive diluents to reduce the viscosity of the dual-cure resin 100. Acrylate monomers 108 may be mono-functional, di-functional, tri-functional, or multi-functional monomers. For example, the acrylate monomers 108 may include, but are not limited to, isobornyl methacrylate (IBMA), 2-carboxyethyl acrylate (CEA), 2-hydroxyethyl acrylate (HEA), ethylene glycol dimethacrylate (EGDMA), neopentyl glycol dimethacrylate (NGDMA), 3-(acryloyloxy)-2-hydroxypropyl methacrylate (AHPMA), trimethylolpropane triacrylate (TMPTA), combinations thereof, or the like. Chain extenders may also be added to the acrylate monomers 108 diluent forming a diluent mixture including the acrylate monomer and a chain extender.

The photoinitiator 110 is used to initiate the polymerization reaction in regions exposed to light (e.g., UV irradiation). The photoinitiator 110 may comprise diphenyl (2,4,6 trimethyl benzoyl) phosphine oxide (TPO), or a combination thereof. The photoinitiator 110 may be activated at 365 nm, 405 nm, or another appropriate wavelength. For example, the photoinitiator 106 comprising TPO may be activated by 365 nm UV light.

The thermal curative(s) 112 included in the second component 104 react with isocyanates that are deblocked after exposure to UV light at increased temperature to form a solidified material. The thermal curatives 112 may be amine curatives such as primary, secondary, or tertiary amines. The amine curatives may be aliphatic amines, aromatic amines, or amines with other modifications. Example amine curatives include, but are not limited to, 4,4′-methylenebis(2-methylcyclohexylamine) (MMCA), poly(propylene glycol)bis(2-aminopropyl ether), 5-amino-1,3,3-trimethylcyclo-hexanemethylamine, trimethylolpropane tris[poly(propylene glycol), an amine-terminated ether, and the like.

Additive(s) 114 may be added to the dual-cure resin 100 and may include stabilizers, plasticizers, porogens, and/or pigments (e.g., carbon black or the like). Porogens are particles (e.g., microspheres) which expand in volume when heated. Expanded porogens, which do not expand when heated, may also be used. For example, Nouryon Expancel microballoons (031DU40) may be used as porogens. Porogens may cause the formation of pores in the CMP pad, which may further improve its performance.

FIG. 2 illustrates an example process 200 for preparing a CMP pad using the dual-cure resin 100 of FIG. 1. In this example, a number of thin layers of pad material may be progressively formed using an additive manufacturing process, such as a 3D printing process, a vat-based additive manufacturing process, or the like. In some embodiment, each layer may be formed via UV-initiated reaction of the dual-cure resin 100 followed by a thermal treatment to form a thin layer of solidified pad material. In other embodiments, the pad material may also be thermally treated after all of the individual layers of the pad are formed via a UV-initiated reaction. The resulting pad is thus formed with a precisely controlled structure by projecting an appropriate pattern of light (e.g., UV irradiation) in a vat-based additive manufacturing process or by controlling printing locations in a 3D printing process. Using process 200, CMP pads may be formed with more tightly controlled physical and chemical properties than is possible using conventional processes. For example, using process 200, CMP pads may be prepared with unique groove and channel structures as well as improved chemical and mechanical properties. Process 200 also facilitates increased manufacturing throughput than is possible using conventional methods.

As shown in FIG. 2, at step 202, the first component 102 is prepared. The first component 102 may be prepared by combining the one or more acrylate-capped oligomers 106, one or more acrylate monomers 108, and at least one photoinitiator 110. First component 102 may also include a chain extender.

As described above in conjunction with FIG. 1, the acrylate-capped oligomers 106 may be selected from acrylate-capped aromatic urethane oligomers, acrylate-capped aliphatic urethane oligomers, or a combination thereof. According to some embodiments, the acrylate-capped urethane oligomers may be de-blockable acrylate-capped urethane oligomers and may include a mixture of a de-blockable acrylate-capped aromatic urethane oligomer and a de-blockable acrylate-capped aliphatic urethane oligomer. The acrylate monomers 108 may be mono-functional, di-functional, tri-functional, or multi-functional monomers. For example, the acrylate monomers 108 may include IBMA, CEA, HEA, EGDMA, NGDMA, AHPMA, TMPTA, or the like. The photoinitiator 110 is a component that initiates a polymerization reaction in regions exposed to UV light (e.g., at 365 nm, 405 nm, or another appropriate wavelength).

At step 204, the second component 104 is prepared. The second component includes at least one thermal curative 112. Examples of thermal curatives 112 are provided above with respect to FIG. 1.

At step 206, the dual-cure resin 100 is prepared by combining the first component 102 and the second component 104. In some embodiments, one or more additives 114 are added to the dual-cure resin 100. Examples of additives 114 are provided above with respect to FIG. 1.

At step 208, at least one layer of a CMP pad is prepared. In embodiments when a layer of the CMP pad is formed using a 3D printing process, the layer may be formed by depositing the dual-cure resin 100 at desired locations (e.g., based on a desired “printing pattern”) using one or more nozzles followed by a UV curing process. In general, deposited regions of the dual-cure resin 100 that are exposed to the UV light under appropriate reaction conditions are radically polymerized. Photo-radical polymerization occurs after exposure to the UV light. Photo-radical polymerization may proceed continuously as the dual-cure resin 100 is deposited. The patterns of grooves and channels may be controlled by a respective printing pattern of each layer. These printing patterns may be controlled by a CAD program that is used to design the patterns of grooves and channels. A thermal curing process may be performed after each layer of the CMP pad is formed or after all or a portion of the layers are formed (e.g., at step 212, described below).

At step 210, a determination (e.g., by a controller or processor of the manufacturing apparatus used to prepare the CMP pad) is made of whether all layers of the CMP pad are complete (e.g., whether a desired pad thickness has been achieved). If the desired number of layers or thickness is not reached, the process 200 returns to step 208 and adds additional layer(s) to the CMP pad. In embodiments when the CMP is formed using a 3D printing process, an additional layer may be formed by depositing the dual-cure resin 100 at desired locations (e.g., based on a desired printing pattern) using one or more nozzles followed by a UV curing process. The additional layer may include the same or a different structure (e.g., of grooves and/or channels) than the previous layer. Additionally, the same or different materials may be used for the formation of different individual layers of the CMP pad. Step 208 is repeated until a desired thickness of the CMP pad is achieved.

Once all layers of the CMP pad are complete at step 210, the process 200 proceeds to step 212. At step 212, post treatment steps may be performed to prepare the CMP pad for storage and/or use. For example, the CMP pad may be removed from its build platform and any chemical and/or physical post treatments may be performed. For example, the CMP pad may be rinsed with one or more solvents. In embodiments when the thermal curing is not performed at step 208, the thermal curing may be performed at step 212 to harden the CMP pad. In embodiments when the thermal curing is performed at step 208, an additional thermal curing process may be performed at step 212 to further harden the CMP pad. In some embodiments, the CMP pad is not rinsed. In some cases, portions of the CMP pad may be backfilled with a second material, as appropriate for a given application. At step 214, the CMP pad is used for a CMP process.

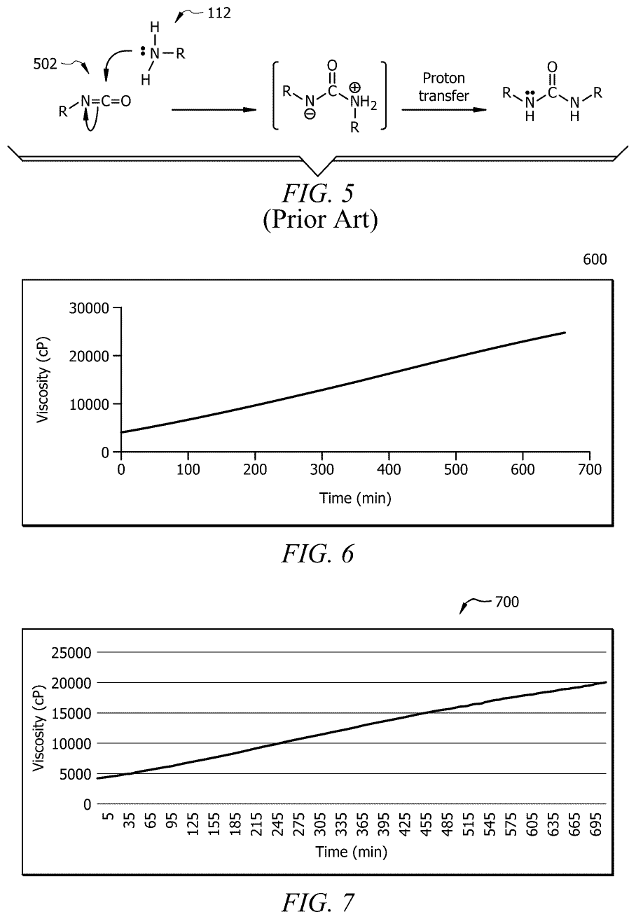

FIGS. 4 and 5 illustrate various reactions between components of the dual-cure resin 100 while performing UV and thermal curing processes, according to an illustrative embodiment of this disclosure.

During UV curing when acrylate-capped oligomers 106 (e.g., de-blockable acrylate-capped urethane oligomers) and acrylate monomers 108 as are exposed to UV light, their acrylate parts go through a free radical addition polymerization and form a ladder-type structure 402, which transforms liquid dual-cure resin 100 into a solid material.

A thermal curing process may be performed after the UV curing step. after each layer of the CMP pad is formed or after all or a portion of the layers are formed. During the thermal curing step the ladder-like acrylate structure breaks off from a backbone and thermal curatives 112 (e.g., diamine curatives) are attached to the open-NCO ends 502 (see FIG. 5) of the backbone to form long chain polymers. Such an exemplary reaction is illustrated in FIG. 5. In some embodiments, cross-linking also takes place during the thermal curing to form a pad material 404 (see FIG. 4).

### EXAMPLES

Formulations of dual-cure resins with different components were prepared and their properties were determined as described below with respect to FIGS. 6-10. TABLE 1 summarizes the different formulations tested and amounts of various components in each formulation. Amounts of various components of the tested formulations are measured in units of percentages by weight (wt %). TABLE 1 also summarizes various parameters (e.g., pot life and aliphatic/aromatic ratio) of the tested formulations and identifies CMP pads formed from respective formulations.

TABLE 1
Components and their amounts in example dual-cure resin formulations.

| | | | | Thermal | | | |
|---|---|---|---|---|---|---|---|
| | | Acrylate-capped | Acrylate | curatives and | | | Aliphatic/ |
| CMP | | oligomers and | monomers and | respective | | | Aromatic |
| PAD ID | Formulation ID | respective amounts | respective amounts | amounts | Pot life | | ratio |
| PAD 1 | Formulation 1 | HEA-PET75D (15.6 | IBMA (28.1 wt %) | MMCA | <2 | hrs | 0 |
| | | wt %) and TBEMA- | and EGDMA | (6.5 wt %) | | | |
| | | PET95A (46.8 wt %) | (3.1 wt %) | | | | |
| PAD 2 | Formulation 2 | HEA-PET75D (15.6 | IBMA (28.1 wt %) | MMCA | >9 | hrs | 55/45 |
| | | wt %), TBEMA- | and EGDMA | (6.3 wt %) | | | |
| | | PET95A (21.1 wt %) | (3.1 wt %) | | | | |
| | | and TBEMA- | | | | | |
| | | APC722 (25.8 wt %) | | | | | |
| PAD 3 | Formulation 3 | HEA-PET60D (15.8 | IBMA (28.4 wt %) | MMCA | >11 | hrs | 55/45 |
| | | wt %), TBEMA- | and EGDMA | (5.3 wt %) | | | |
| | | PET90A (21.3 wt %) | (3.2 wt %) | | | | |
| | | and TBEMA- | | | | | |
| | | APC722 (26 wt %) | | | | | |
| PAD 4 | Formulation 4 | HEA-PET60D (15.8 | IBMA (31.5 wt %) | MMCA | >12 | hrs | 60/40 |

| | | |
|---|---|---|
| wt %), TBEMA- | and EGDMA | (5.4 wt %) |
| PET90A (18.9 wt %) | (3.2 wt %) | |
| and TBEMA- | | |
| APC722 (28.4 wt %) | | |

Formulation 1 may further comprise 4 wt % porogens. Formulation 2 may further comprise 5 wt % porogens. Formulation 3 may further comprise 3.5 wt % porogens. Formulation 4 may further comprise 3.5 wt % porogens.

Different dual-cure resin formulations may have different pot lives. A pot life of a formulation may be defined as a time needed to reach a viscosity of 35,000 cP, at which viscosity the formulation gels. A pot life may be altered by altering an aliphatic/aromatic ratio of the acrylate-capped oligomers 106 in a formulation. In some embodiments, a pot life of a formulation may be improved by increasing the aliphatic/aromatic ratio. Formulation 1 having the aliphatic/aromatic ratio of 0 (i.e., not comprising acrylate-capped aliphatic oligomers) has a pot life of less than 2 hrs. Formulation 2 having the aliphatic/aromatic ratio of 55/45 (i.e., comprising both acrylate-capped aliphatic and aromatic oligomers) has a pot life of greater than 9 hrs. Formulation 2 reaches the viscosity of 35,000 cP in 9.3 hrs. Formulation 3 having the aliphatic/aromatic ratio of 55/45 (i.e., comprising both acrylate-capped aliphatic and aromatic oligomers) has a pot life of greater than 11 hrs. A plot 600 of a viscosity versus time for Formulation 3 is illustrated in FIG. 6. Formulation 3 reaches the viscosity of 24,690 cP in 11 hrs. Formulation 4 having the aliphatic/aromatic ratio of 60/40 (i.e., comprising both acrylate-capped aliphatic and aromatic oligomers) has a pot life of greater than 12 hrs. A plot 700 of a viscosity versus time for Formulation 4 is illustrated in FIG. 7. Formulation 4 reaches the viscosity of 20,000 cP in 12 hrs. As demonstrated, the additional of a de-blockable aliphatic oligomer to the dual-cure resin formulation can significantly increase pot like which is advantageous when using an additive manufacturing process to produce a CMP pad.

Various performance parameters for different CMP pad samples were determined by performing CMP experiments using slurries (e.g., D7400 and D8600) from CMC Materials. TABLE 2 summarizes performance parameters for sample and control CMP pads. The control CMP pad is the E6088 CMP pad commercially available from CMC Materials.

TABLE 2
Performance parameters for sample and control CMP pads.

| | | | | | Planari- |
|---|---|---|---|---|---|
| | | Hard- | | | zation |
| | Den- | ness | Removal | Pad Wear | Effi- |
| CMP | sity | (Shore | Rate (RR) | Rate | ciency |
| PAD ID | (g/cc) | D) | (Å/min) | (PWR) | (PE) |
| PAD 1 | 0.8 | 60 | RR of Control | Delta-average | 1 X |
| | | | PAD = 8198 | 75 locations | PE of |
| | | | Å/min (using | (grooves lost | Control |
| | | | D7400 slurry) | post polish) of | PAD |
| | | | RR of PAD 1 = | PAD 1 = | |
| | | | 8055 Å/min | −5.6424 mils | |
| | | | (using | Delta-average | |
| | | | D7400 | 75 locations | |
| | | | slurry) | (grooves lost | |
| | | | RR of PAD 1 = | post polish) of | |
| | | | 98.3% X RR of | Control PAD = | |
| | | | Control PAD | −5.0454 mils | |
| | | | (using D7400 | PWR of PAD | |
| | | | slurry) | 1 = 1.1 X PWR | |
| | | | | of Control PAD | |
| PAD 2 | 0.66 | 57 | RR of Control | Delta-average | N/A |
| | | | PAD = | 75 locations | |
| | | | 8076 Å/min | (grooves lost | |
| | | | (using D7400 | post polish) of | |
| | | | slurry) | PAD 2 = | |
| | | | RR of PAD | −1.4849 mils | |
| | | | 2 = 7841 | Delta-average | |
| | | | Å/min (using | 75 locations | |
| | | | D7400 slurry) | (grooves lost | |
| | | | RR of PAD 2 = | post polish) of | |
| | | | 97.1% X RR of | Control PAD = | |
| | | | Control PAD | −1.0358 mils | |
| | | | (using D7400 | PWR of | |
| | | | slurry) | PAD 2 = | |
| | | | | 1.4 X PWR of | |
| | | | | Control PAD | |
| PAD 3 | 0.83 | 59 | RR of Control | Delta-average | N/A |
| | | | PAD = | 75 locations | |
| | | | 8242 Å/min | (grooves lost | |
| | | | (using | post polish) of | |
| | | | D7400 slurry) | PAD 3= | |
| | | | RR of PAD 3 = | −1.3244 mils | |
| | | | 8182 Å/min | Delta-average | |
| | | | (using | 75 locations | |
| | | | D7400 slurry) | (grooves | |
| | | | RR of PAD 3 = | lost post | |
| | | | 99.3% X RR of | polish) of | |
| | | | Control PAD | Control PAD = | |
| | | | (using D7400 | −0.6866 mils | |
| | | | slurry) | PWR of | |
| | | | RR of Control | PAD | |
| | | | PAD = 9917 | 2 = | |
| | | | Å/min (using | 1.92 X PWR | |
| | | | D8600 slurry) | of Control | |
| | | | RR of | PAD | |
| | | | PAD 3 = | | |
| | | | 10439 Å/min | | |
| | | | (using D8600 | | |
| | | | slurry) | | |
| | | | RR of PAD 3 = | | |
| | | | 105.3% X RR | | |
| | | | of Control PAD | | |
| | | | (using D8600 | | |
| | | | slurry) | | |
| PAD 4 | 0.84 | 60 | RR of Control | Delta-average | N/A |
| | | | PAD = 8242 | 75 locations | |
| | | | Å/min (using | (grooves lost | |
| | | | D7400 slurry) | post polish) of | |
| | | | RR of PAD 4 = | PAD 4 = | |
| | | | 8144 Å/min | −1.8247 mils | |
| | | | (using | Delta-average | |
| | | | D7400 slurry) | 75 locations | |
| | | | RR of PAD 4 = | (grooves lost | |
| | | | 98.8% X RR of | post polish) of | |
| | | | Control PAD | Control PAD = | |
| | | | (using D7400 | −0.6866 mils | |
| | | | slurry) | PWR of | |
| | | | RR of Control | PAD 2 = | |
| | | | PAD = 9917 | 2.65 X PWR | |
| | | | Å/min (using | of Control | |
| | | | D8600 slurry) | PAD | |
| | | | RR of PAD 4 = | | |
| | | | 10296 Å/min | | |
| | | | (using D8600 | | |
| | | | slurry) | | |
| | | | RR of PAD 4 = | | |
| | | | 103.8% X RR | | |
| | | | of Control PAD | | |
| | | | (using D8600 | | |
| | | | slurry) | | |
| CON- | 0.8 | 60 | 100% of RR of | 1 X PWR of | 1X |
| TROL | | | Control PAD | Control PAD | PE of |
| PAD | | | (using D7400 | | Control |
| (E6088) | | | and D8600 | | PAD |
| | | | slurries) | | |

In certain embodiments, PADs 1 through 4 may be formed by the process 200 described above with respect to FIG. 2. PAD 1 has a density of 0.8 g/cc that is similar to a density of CONTROL PAD. PAD 1 has a hardness of 60 that is similar to a hardness of CONTROL PAD. PAD 1 has a removal rate (RR) that is 98.3% of a RR of CONTROL PAD while using D7400 slurry. PAD 1 has a pad wear rate (PWR) that is similar to a PWR of CONTROL PAD. PAD 1 has a planarization efficiency (PE) that is similar to a PE of CONTROL PAD.

PAD 2 has a density of 0.66 g/cc. PAD 2 has a hardness of 57. PAD 2 has a RR that is 97.1% of the RR of CONTROL PAD while using D7400 slurry. PAD 2 has a PWR that is 1.4 times the PWR of CONTROL PAD.

PAD 3 has a density of 0.83 g/cc. PAD 3 has a hardness of 59. PAD 3 has a RR that is 99.3% of the RR of CONTROL PAD while using D7400 slurry. PAD 3 has a RR that is 105% of the RR of CONTROL PAD while using D8600 slurry. PAD 3 has a PWR that is 1.9 times the PWR of CONTROL PAD.

PAD 4 has a density of 0.84 g/cc. PAD 3 has a hardness of 60. PAD 4 has a RR that is 98.8% of the RR of CONTROL PAD while using D7400 slurry. PAD 4 has a RR that is 104% of the RR of CONTROL PAD while using D8600 slurry. PAD 4 has a PWR that is 2.6 times the PWR of CONTROL PAD.

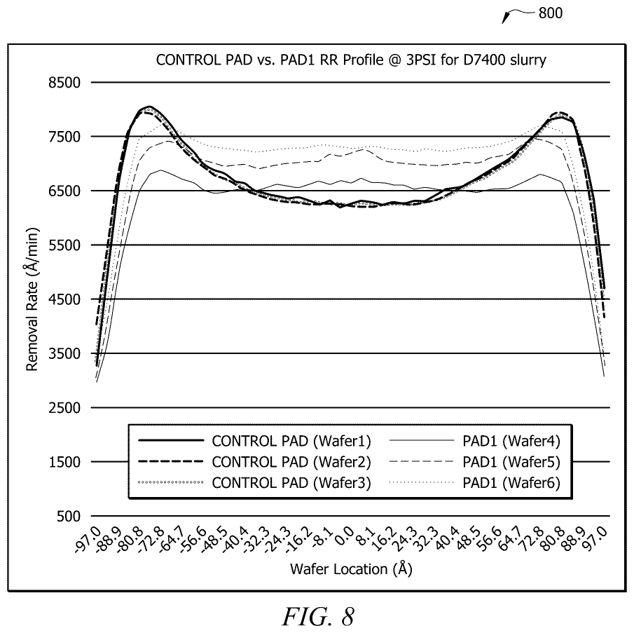

FIG. 8 shows a plot 800 of RRs achieved by CONTROL PAD for Wafer1, Wafer2, and Wafer3, and PAD 1 for Wafer4, Wafer5, and Wafer6 while using D7400 slurry. In the illustrated embodiment, Wafer 1 through Wafer 6 are wafers of a same type. PAD 1 has the RR that is 98.3% of the RR of CONTROL PAD while using D7400 slurry.

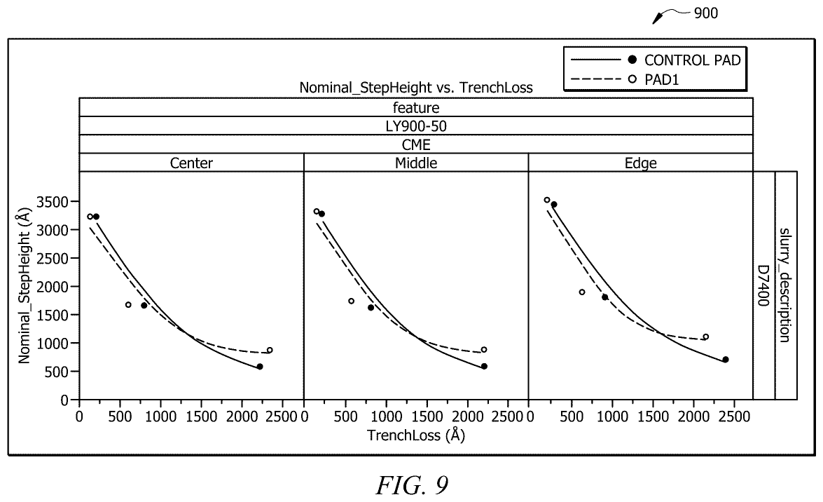

FIG. 9 shows a plot 900 of PE performances for PAD 1 and the CONTROL PAD while using D7400 slurry. PAD 1 has the PE that is similar to the PE of CONTROL PAD.

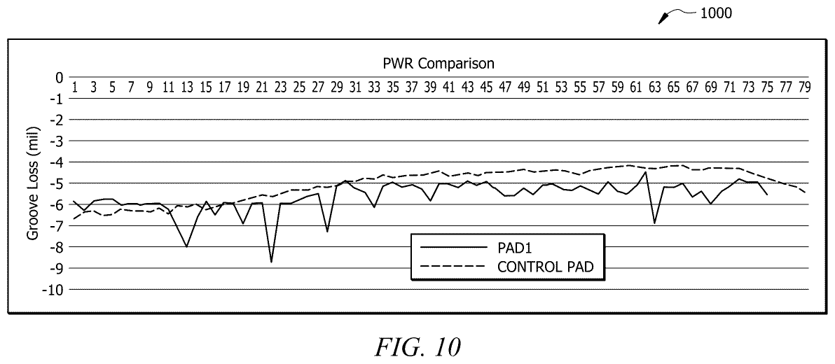

FIG. 10 shows a plot 1000 of PWRs for PAD 1 and the CONTROL PAD while using D7400 slurry. PAD 1 has the PWR that is similar to the PWR of CONTROL PAD.

Modifications, additions, or omissions may be made to the systems, apparatuses, and methods described herein. The components of the systems and apparatuses may be integrated or separated. Moreover, the operations of the systems and apparatuses may be performed by more, fewer, or other components. The methods may include more, fewer, or other steps. Additionally, steps may be performed in any suitable order. Additionally, operations of the systems and apparatuses may be performed using any suitable logic. As used in this document, “each” refers to each member of a set or each member of a subset of a set.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A formulation for preparing a chemical-mechanical polishing pad via photopolymerization and heating, the formulation comprising:
a first component comprising:
one or more acrylate-capped oligomers;
one or more acrylate monomers; and
at least one photoinitiator; and
a second component comprising one or more thermal curatives.

2. The formulation of claim 1, wherein the one or more acrylate-capped oligomers is a de-blockable acrylate-capped oligomer.

3. The formulation of claim 1, wherein the one or more acrylate monomers comprise one or more of isobornyl methacrylate (IBMA), 2-carboxyethyl acrylate (CEA), 2-hydroxyethyl acrylate (HEA), ethylene glycol dimethacrylate (EGDMA), neopentyl glycol dimethacrylate (NGDMA), 3-(acryloyloxy)-2-hydroxypropyl methacrylate (AHPMA), and trimethylolpropane triacrylate (TMPTA).

4. The formulation of claim 1, wherein the at least one photoinitiator comprises diphenyl (2,4,6 trimethyl benzoyl) phosphine oxide (TPO).

5. The formulation of claim 1, wherein the thermal curatives comprise amine curatives.

6. The formulation of claim 1, wherein the one or more acrylate-capped oligomers comprises a de-blockable acrylate blocking agent and an isocyanate-terminated urethane prepolymer.

7. The formulation of claim 6, wherein the de-blockable acrylate blocking agent comprises 2-(tert-butylamino) ethyl methacrylate (TBEMA).

8. The formulation of claim 6, wherein the isocyanate-terminated urethane prepolymers comprise one or both of one or more aromatic prepolymers and one or more aliphatic prepolymers.

9. The formulation of claim 1, wherein the one or more acrylate-capped oligomers comprises a mixture of a de-blockable acrylate-capped aromatic urethane oligomer and a de-blockable acrylate-capped aliphatic urethane oligomer.

10. The formulation of claim 9, wherein the formulation has a pot life of greater than 9 hrs.

11. The formulation of claim 9, wherein the formulation has a pot life of greater than 11 hrs.

12. The formulation of claim 9, wherein the formulation has a pot life of greater than 12 hrs.

13. The formulation of claim 9, wherein the one or more acrylate-capped oligomers comprises a mixture of a de-blockable acrylate-capped aromatic urethane oligomer and a de-blockable acrylate-capped aliphatic urethane oligomer having an aliphatic/aromatic ratio of at least 55/45.

14. A chemical-mechanical polishing pad comprising polymerized material formed from polymerization of the composition of claim 1.

15. A method of forming a chemical-mechanical polishing pad, the method comprising:
preparing the composition of claim 1;
depositing a portion of the composition using an additive manufacturing process;
exposing the portion of the composition to ultraviolet light to initiate a polymerization reaction and form at least a layer of solidified pad material; and
heating the layer.
